(19) United States
(12) Patent Application Publication
(10) Pub. No.: US 2017/0368691 A1
(43) Pub. Date: Dec. 28, 2017

(54) Mobile Robot Navigation

(71) Applicant: Dilili Labs, Inc., Santa Clara, CA (US)

(72) Inventor: Dexin Li, Fremont, CA (US)

(73) Assignee: Dilili Labs, Inc., Santa Clara, CA (US)

(21) Appl. No.: 15/634,638

(22) Filed: Jun. 27, 2017

Related U.S. Application Data
(60) Provisional application No. 62/354,940, filed on Jun. 27, 2016.
(60) Provisional application No. 62/354,944, filed on Jun. 27, 2016.

(51) Int. Cl. B25J 13/08; B25J 9/16

(52) U.S. Cl. CPC B25J 13/089; B25J 9/1676

(57) ABSTRACT

A double-threshold mechanism is used for implementing the follow-me function of a mobile robot. Initially, a user comes to a mobile robot and turns on its follow-me function. Then, the mobile robot is in the follow-me mode or can simply be described as following the user. When the user moves away from the robot, the robot determines whether the distance between itself and the user exceeds a first distance threshold. If so, the robot starts moving to follow the user. Otherwise, the robot stays put. While following the user's movement, the robot continues to monitor the distance between itself and the user. When the robot determines that the distance between them is less than a second distance threshold—because the user has slowed down or stopped, for example—the robot stops moving. The second distance threshold is lower than the first distance threshold.

### CROSS-REFERENCE TO RELATED APPLICATIONS

This application claims priority to U.S. Provisional Patent Application Ser. Nos. 62/354,944, filed Jun. 27, 2016, and 62/354,940, filed Jun. 27, 2016, the entire contents of which are incorporated herein by reference.

### FIELD OF INVENTION

This invention generally relates to robotic technology. Specifically, this invention relates to mobile robot navigation.

### BACKGROUND OF THE INVENTION

For a mobile robot (including any self-driving vehicle), the ability to navigate in its environment while avoiding dangerous situations such as collisions and unsafe conditions (temperature, radiation, exposure to weather, uneven surface, etc.) is critically important. Autonomous navigation or semi-autonomous navigation (such as the so-called “follow-me” function) requires a robot to determine its own position and orientation within the frame of reference or coordinates (i.e., localization) and then to plan a path towards some goal location (i.e., path planning).

The follow-me function of a mobile robot is an important and useful function. With this function, a mobile robot can carry heavy items for a user and follow the user to move around. Also, the follow-me function can serve as a mechanism for training the mobile robot. For example, a user can use the follow-me function to train a mobile robot to learn a particular navigation path so that it can navigate the same path autonomously.

One way of implementing the follow-me function of a mobile robot is to determine whether the distance and/or orientation between the mobile robot and the user has changed. If so, the mobile robot will move accordingly to maintain the same distance and/or orientation with the user. Although this mechanism is easy to implement, it makes the mobile robot too “sensitive” to the user's movement, no matter how small the movement may be. Thus, it may cause the robot to move unnecessarily and/or unnaturally sometime, therefore affecting user experience and consuming unnecessary battery power of the mobile robot. Furthermore, if a mobile robot is too “sensitive” to a user's movement, it could change its position, speed, or state too abruptly, therefore can pose a potential physical threat to people nearby.

Thus, a new and better follow-me solution is needed to allow a mobile robot to shadow a user's movement more naturally and smoothly and avoid abrupt changes of direction or motions.

### SUMMARY OF THE INVENTION

In one embodiment of the present invention, a double-threshold mechanism is used for implementing the follow-me function of a mobile robot. Initially, a user comes to a mobile robot and turns on its follow-me function. Then, the mobile robot is in the follow-me mode or can simply be described as following the user. When the user moves away from the robot, the robot determines whether the distance between itself and the user exceeds a first distance threshold. If so, the robot starts moving to follow the user. Otherwise, the robot stays put. While following the user's movement, the robot continues to monitor the distance between itself and the user. When the robot determines that the distance between them is less than a second distance threshold—because the user has slowed down or stopped, for example—the robot stops moving (i.e., navigation speed equals to 0). The second distance threshold is lower than the first distance threshold.

The robot described above also monitors the user's moving direction (or simply “direction”) so that it can follow the user's turns. In one embodiment, if the user's movement is within a distance range from the robot, the robot will not move, turn, or pivot. The distance range is defined as a circle centered at the robot and having a radius equal to the first distance threshold. In another embodiment, the radius of the circle may be less than the first distance threshold but greater than the second distance threshold.

In another embodiment of the present invention, the robot will alert a user if the user is too close to the robot. For example, if the robot determines that its distance from the user is less than or equal to a third distance threshold, which may be lower than the second distance threshold, the robot may sound an alarm or flash a red light to warn the user.

In yet another embodiment of the present invention, the robot intentionally avoids following or reacting to a user's abrupt change of direction that exceeds a specified threshold. Instead, the robot waits until the user's moving direction stabilizes and then determines its moving direction based on the user's then moving speed, direction, and/or position.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the leftmost digit of a reference number identifies the drawing in which the reference number first appears.

FIG. 1 is a system diagram of a mobile robot.

FIG. 2 illustrates a two-threshold follow-me solution according to one embodiment of the present invention.

FIG. 3 is a flow diagram illustrating a process of a mobile robot's follow-me function according to one embodiment of the present invention.

FIG. 4A illustrates a scenario where a mobile robot avoids following a user's series sharp turns according to one embodiment of the present invention.

FIG. 4B illustrates a scenario where a mobile robot does not follow a user's sharp turn until the user's moving direction stabilizes after the sharp turn according to one embodiment of the present invention.

FIG. 4C illustrates a scenario where a mobile robot follows a user's series minor turns according to one embodiment of the present invention.

FIG. 5 is a flow diagram illustrating a process of a mobile robot's follow-me function according to one embodiment of the present invention.

FIG. 6 is a diagram illustrating the determination of a user's moving direction.

FIG. 7 illustrates an example of using a constructed map and a series of coordinates to record a robot's moving path during a follow-me training session.

FIG. 8 illustrates an exemplary data structure of a recorded path.

FIGS. 9A-9D illustrate an example of circumventing an obstacle by a mobile robot.

### DETAILED DESCRIPTION

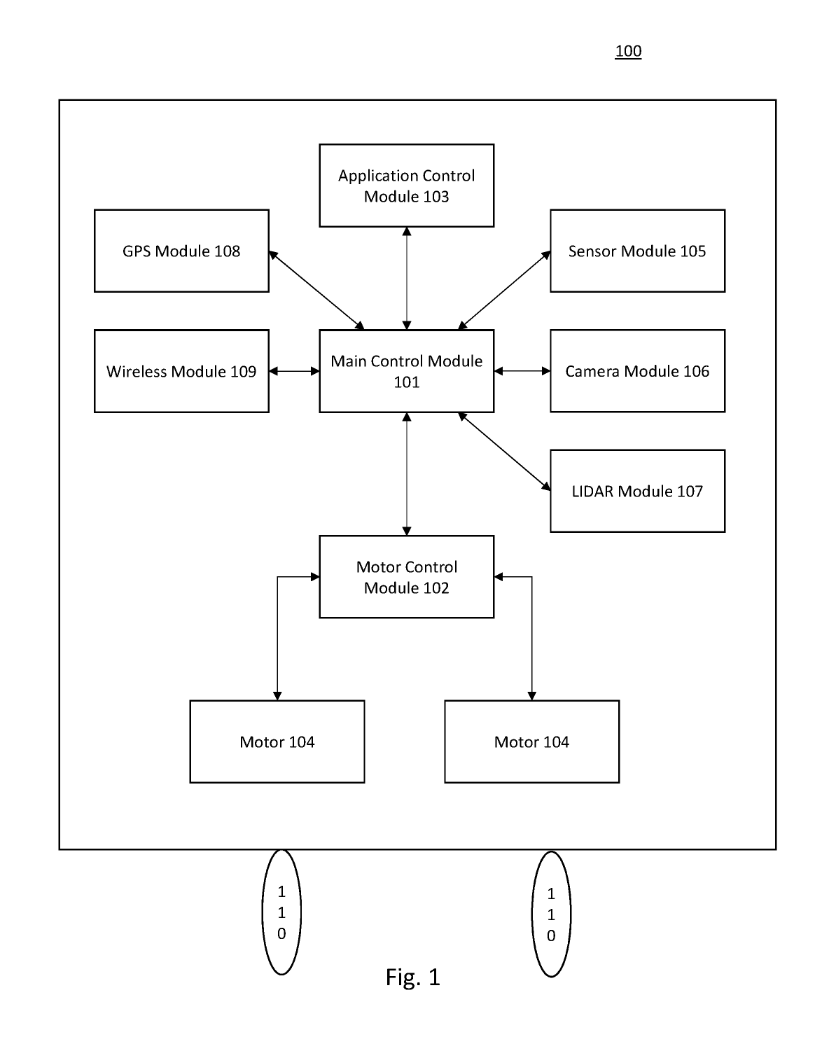

FIG. 1 is a system diagram of a mobile robot. In one embodiment, the mobile robot 100 has a main control module 101, a motor control module 102, an application module 103, a plurality of motors 104, a sensor module 105, a camera module 106, a LIDAR module 107, a GPS module 108, a wireless module 109, and a plurality of wheels 110.

The sensor module 105 includes one or more sensors (e.g., ultrasonic sensor, infrared sensor) for collecting location related data regarding the mobile robot 100 and/or a target object. In addition, the LIDAR module 107, GPS module 108, and/or wireless module 109 may also be used for collecting location related data.

The main control module 101 receives the location related data and calculates a navigation plan for the mobile robot 100 (including moving direction, distance, and speed) based on the location related data. The motor control module 102 receives the navigation plan from the main control module 101 and generates corresponding control signals for the plurality of motors 104, which drive the wheels 110 to move the mobile robot 100 according to the calculated navigation plan.

In addition, the main control module 101 may receive real-time images of the surrounding environment of the mobile robot 100 from the camera module 106 and use computer vision technologies to guide the robot's navigation. The main control module 101 may rely on the sensor data, the camera images, the GPS data, the wireless data, or the combination of them on calculating the navigation plan. The camera module 106 may further include a depth sensor to enable the camera module to capture 3-D images.

It should be noted that the sensor module 105, camera module 106, LIDAR module 107, GPS module 108, and wireless module 109 each have its own advantages and disadvantages. The mobile robot 100 may include some or all of these modules for localization and/or navigation purposes. In addition, the main control module 101 may use data received from one or more of these modules to construct or update a map of the robot's surrounding environment by using, for example, Simultaneous Localization and Mapping (SLAM) technologies.

The application control module 103 contains various applications which either add new functions to the mobile robot 100 or enhance its capability in certain areas. For example, when such a mobile robot works as a shopping assistant in a shopping mall, an e-commerce application would be helpful for the robot to interact with a customer, provide information regarding the product or store the customer is looking for, or even facilitate a purchase transaction. The main control unit 101 may also offload certain functions or computing responsibilities to the application control module 103.

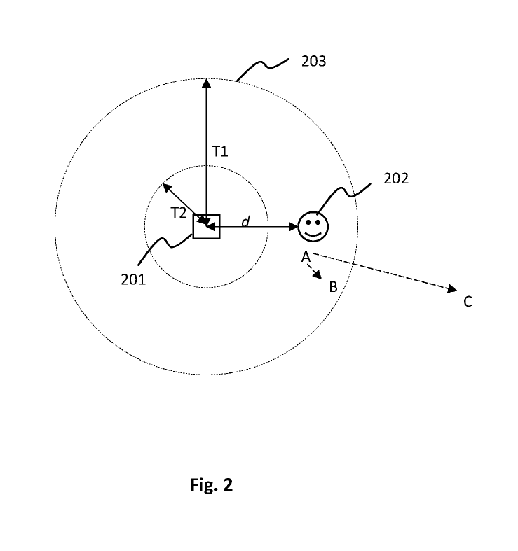

In one embodiment of the present invention, a double-threshold mechanism is used for implementing the follow-me function of a mobile robot. As shown in FIG. 2, a mobile robot 201 determines in real-time the distance d between itself and a user 202 whom it is following. As discussed above, the robot 201 may use sensors (e.g., ultrasonic sensors, infrared sensors, depth sensors), LIDAR, or computer vision technology to determine the distance d. In one embodiment, when d is less than a first threshold T1, the robot 201 does not move, turn, or pivot. In other words, as long as the user 202's movement is confined within the range 203, defined as a circle centered at the robot 201 and having a radius equal to T1, the robot remains still. For example, if the user 202 moves from point A to point B, both are within the range 203, the robot 201 does not move, turn, or pivot. However, if the user 202 moves from point A to point C, where point C is outside of the range 203, the robot 201 will start moving to follow the user 202 as soon as the user 202 crosses the border of the range 203 (i.e., when d is equal to the first threshold T1). The robot 201 calculates its speed based on the user's speed so that it can maintain a relatively constant distance D from the user 202. In one embodiment, D may be equal to or slightly greater than T1.

While being followed by the robot 201, the user 202 may slow down or stop. Instead of stopping immediately, the robot 201 continues its movement towards the user 202 until the distance d between the robot 201 and the user 202 decreases to a second threshold T2. In other words, the robot 201 stops when d is equal to or less than T2. In one embodiment, the robot 201 reduces its speed while d is becoming shorter and shorter so that it can easily stop when d reaches the second threshold T2.

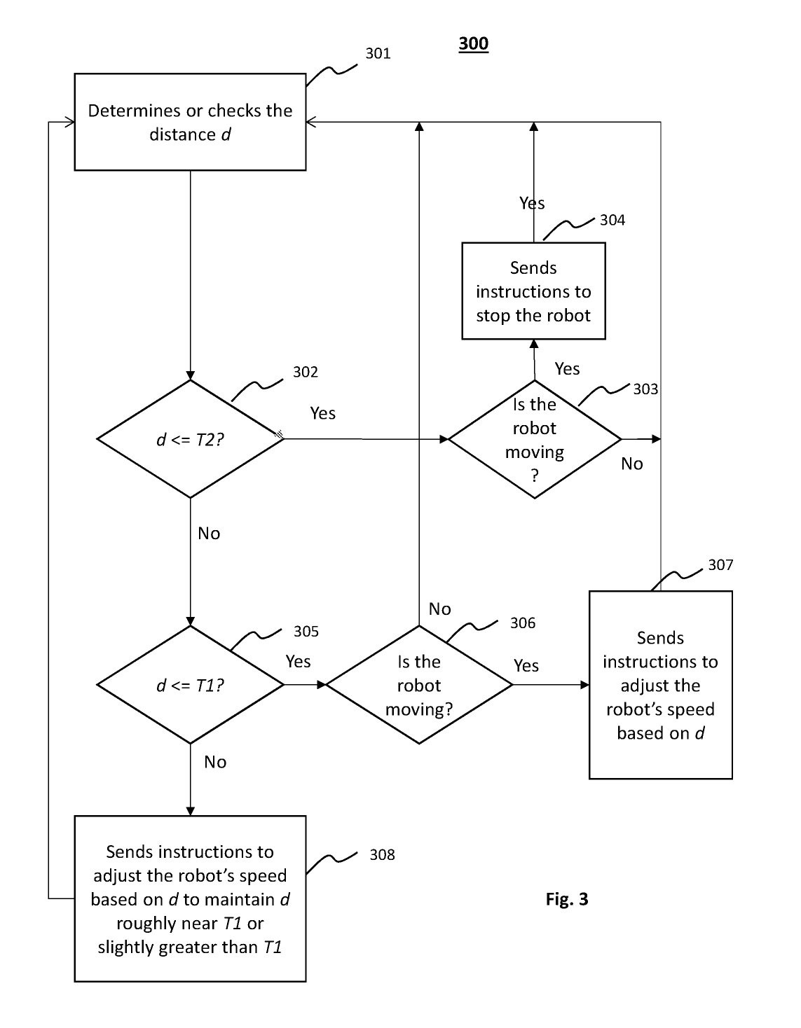

FIG. 3 is a flow diagram illustrating a process 300 of a mobile robot's follow-me function according to one embodiment of the present invention.

In one embodiment, the process 300 is executed by the main control module of a mobile robot, such as the one shown in FIG. 1. Also, it is assumed that the robot is currently in the follow-me mode to follow a user.

At step 301, the mobile robot determines or checks the distance d between itself and the user. As discussed above, the robot may use sensors (e.g., ultrasonic sensors, infrared sensors, depth sensors), LIDAR, or computer vision technology to determine the distance d.

In one embodiment, the determination of the distance d may be a separate and independent process which runs concurrently or in parallel with the process 300. The distance determination process may calculate the distance d in real-time so that the process 300 may check its value whenever needed.

At step 302, the process 300 determines whether d is less than or equal to the second threshold T2. If so, the process 300 goes to step 303.

At step 303, the process 300 determines whether the robot is currently moving (i.e., navigation speed is greater than 0). If so, the process 300 sends instructions to the motor control module of the robot to stop the robot. If the robot is not moving, the process 300 goes back to step 301 to start a new round of processing.

At step 302, if the process 300 determines that the distance d is greater than the second threshold T2, the process 300 goes to step 305. At step 305, the process 300 determines whether the distance d is less than or equal to the first threshold T1. If so, the process 300 goes to step 306, where it determines whether the robot is currently moving. If the robot is currently moving, the process 300 goes to step 307. If the robot is not moving, as determined at step 306, the process 300 goes back to step 301.

At step 307, the process 300 sends instructions to the motor control module to adjust the robot's speed based on the value of d. In one embodiment, the robot's speed increases while d increases and its speed decreases while d decreases. Thus, if the user slows down while the robot is following the user's movement, causing the distance d to decrease, the robot will slow down as well. If the user stops, the robot will slow down first and stop when d reaches to the second distance threshold T2, making the robot's stop more smooth and natural. If the user speeds up again, causing the distance d to increase, the robot will increase its speed to keep up with the user. In one embodiment, the adjustment of the robot's speed may be implemented with a lookup table, which takes various values (e.g., the robot's current speed, the distance d, the user's speed) as inputs and outputs the adjusted speed for the robot.

If the process 300 determines, at step 305, that d is greater than or equal to the first threshold T1, the process 300 goes to step 308. As illustrated in FIG. 2, this scenario occurs if the user is crossing the border of the range 203. At step 308, the process 300 sends instructions to the motor control module to adjust the robot's speed based on d to maintain a relatively constant distance D from the user. In one embodiment, D may be equal to or slightly greater than T1.

It should be noted that the conditions at steps 302 and 305 may be d<T2 and d<T1, respectively. Also, a third distance threshold T3 may be used for detecting whether a user is too close to the robot. T3 may be less than or equal to T2. If the process 300 determines that d is less than or equal to T3, it will instruct the robot to alert the user (e.g., sounds an alarm, flash a red light).

In one embodiment of the present invention, the mobile robot described above intentionally avoids following or reacting to a user's abrupt change of direction that exceeds a first threshold Ø1 (e.g., 30°). Instead, the robot waits until the user's moving direction stabilizes and then determines its moving direction based on the user's current moving direction, speed, and/or position. A user's moving direction may be considered as stabilized if its change has always been less than or equal to a second threshold Ø2 during a predetermined timeframe (e.g., 3 seconds). The second threshold Ø2 may be equal to or lower than the first threshold Ø1. This mechanism helps a mobile robot to move more smoothly and naturally, avoiding unnecessary or abrupt direction changes that could unbalance the robot or endanger people nearby.

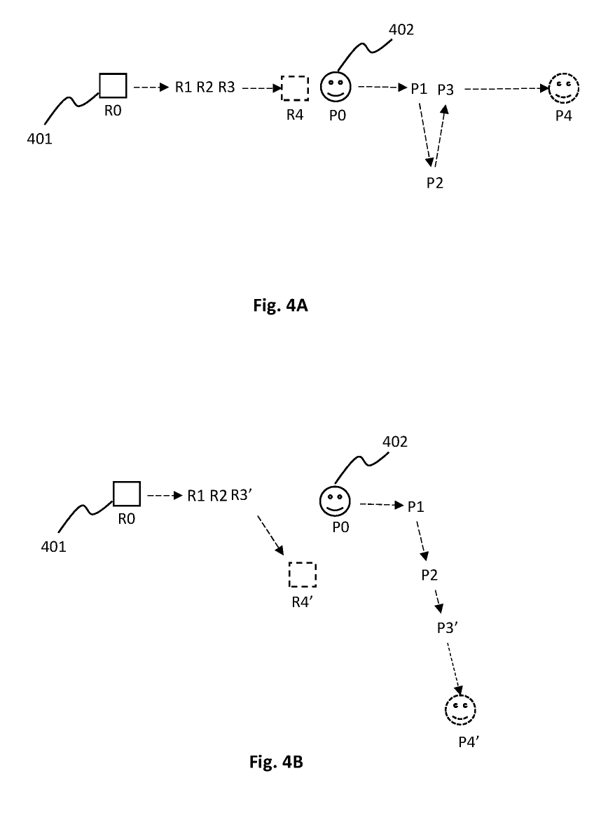

FIG. 4A illustrates a scenario where a mobile robot avoids following a user's series sharp turns according to one embodiment of the present invention. As shown in FIG. 4A, a mobile robot 401 is following the movement of a user 402. Initially, the mobile robot 401 is at location R0 and the user 402 is at location P0. While the user 402 moves from P0 to P1, the robot 401 follows the user 402 and moves from R0 to R1. Then, the user 402 makes two quick sharp turns at P1 and P2 for certain reasons. For example, the user 402 may make these sharp turns to quickly pick up something at P2 or avoid an obstacle or person in the front. Here, the mobile robot 401 determines that the user's first direction change (from direction P0→P1 to direction P1→P2) exceeds a first threshold Ø1 (e.g., 30°). As such, the mobile robot 401 does not change its own moving direction. In one embodiment, the mobile robot 401 may slow down to prepare to stop if the user 402 is trying to avoid an obstacle or person in the front. The mobile robot 401 may use its camera or sensors to check whether such an obstacle or person indeed exists. If so, the mobile robot 401 stops itself to avoid collision with the obstacle or person. Otherwise, the mobile robot 401 navigates at a low speed in its original direction until the user's moving direction stabilizes. As shown, the mobile robot 401 moves from R1 to R2 at a low speed in its original direction R0→R1.

Next, as shown in FIG. 4A, the mobile robot 401 determines that the user's second direction change (from direction P1→P2 to direction P2→P3) also exceeds the first threshold Ø1 and occurred within a specified timeframe (e.g., 3 seconds) from the first direction change. As such, the mobile robot 401 considers that the user's moving direction has not been stabilized and continues to navigate at a low speed from R2 to R3 in its original direction R0→R1.

Then, the user 402 makes a third direction change (from direction P2→P3 to direction P3→P4). This time, the user 402 has not made any sharp turn within the specified timeframe from the third direction change. As such, the mobile robot 401 considers the user's moving direction stabilized and adjusts its speed and direction based on the user's moving direction, speed, and/or position. In one embodiment, the adjustment of the robot's direction may also be implemented with a lookup table, similar to the adjustment of the speed as described above. For example, the lookup table may take various variables (e.g., the robot's current speed, the user's speed, the user's position relative to the robot) as inputs and outputs the adjusted direction for the robot. In one embodiment, the two lookup tables (one for the adjustment of speed and the other for the adjustment of direction) may be implemented as separate lookup tables. Alternatively, these the two lookup tables may be implemented as a single lookup table.

FIG. 4B illustrates a scenario where a mobile robot does not follow a user's sharp turn until the user's direction stabilizes after the sharp turn according to one embodiment of the present invention. Similar to the scenario illustrated in FIG. 4A, the mobile robot 401 is following the movement of the user 402. Initially, the mobile robot 401 is at location R0 and the user 402 is at location P0. While the user 402 moves from P0 to P1, the robot 401 follows the user 402 and moves from R0 to R1. Then, the user 402 makes a sharp turn at P1 and moves to P2. The mobile robot 401 slows down at R1 when it detects the user's sharp turn at P1. If there is no obstacle or person in the front, it moves to R2 at a low speed.

Instead of making another sharp turn at P2, as occurred in the scenario illustrated in FIG. 4A, the user 402 continues to move to P3′ in direction P1→P2 within the specified timeframe (e.g., 3 seconds) from the moving direction change at P1. Here, the mobile robot 401 continues to move to R3′ at a low speed. At R3′, it determines that the user's moving direction has been stabilized. As such, the mobile robot 401 adjusts its moving direction and speed based on the user's moving direction, speed, and position at P3′.

FIG. 4C illustrates a scenario where a mobile robot follows a user's series minor turns according to one embodiment of the present invention. Similar to the scenario illustrated in FIG. 4A, the mobile robot 401 is following the movement of the user 402. Initially, the mobile robot 401 is at location R0 and the user 402 is at location P0. While the user 402 moves from P0 to P1, the robot 401 follows the user 402 and moves from R0 to R1. At P1, the user 402 makes a minor turn and moves to P2″. The mobile robot 401 determines that the user's direction change from direction P0→P1 to direction P1→P2″ does not exceed the first threshold Ø1 (e.g., 30°). Thus, the mobile robot 401 adjusts its direction at R1 based on the user's change of direction. Similarly, neither the user's change of direction at P2″ nor the change of direction at P3″ exceeds the first threshold Ø1. As such, the mobile robot 401 adjusts its direction accordingly at R2″ and R3″, respectively.

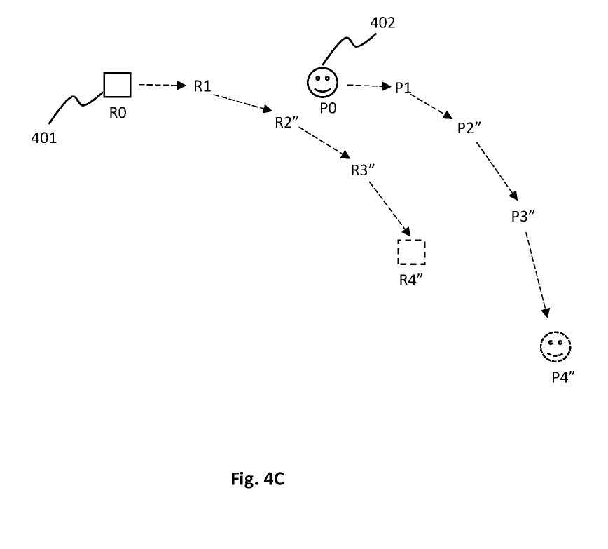

FIG. 5 is a flow diagram illustrating a process 500 of a mobile robot's follow-me function according to one embodiment of the present invention.

In one embodiment, the process 500 is executed by the main control module of a mobile robot, such as the one shown in FIG. 1. Also, it is assumed that the robot is currently in the follow-me mode to follow a user.

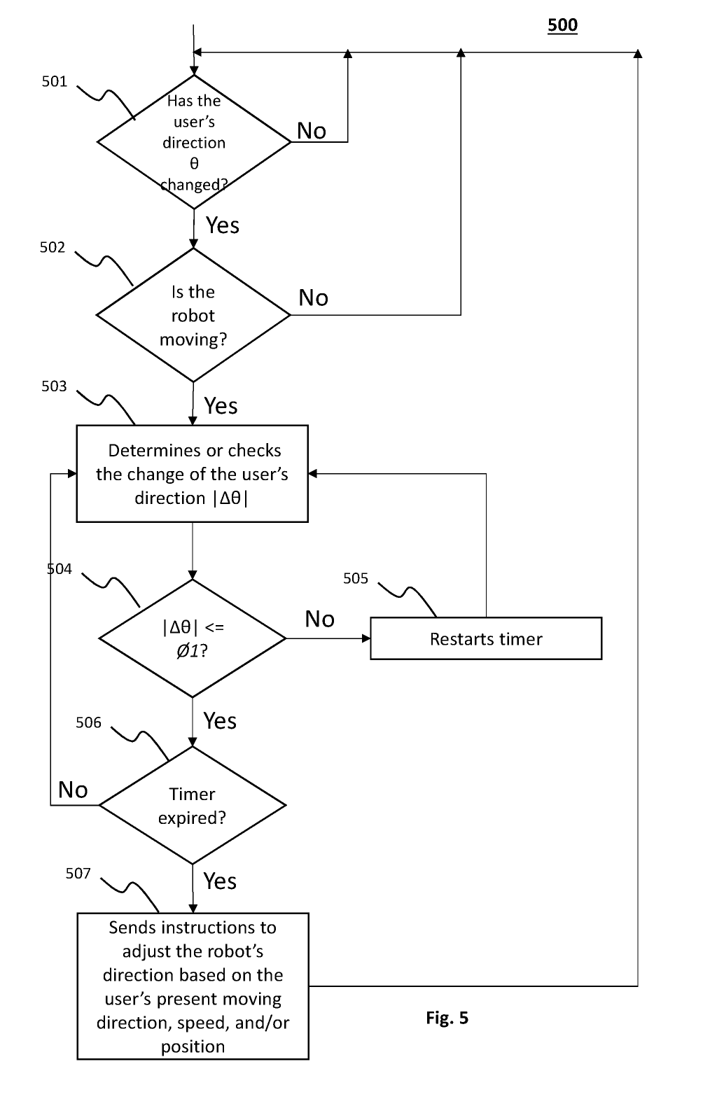

At step 501, the process 500 determines or checks whether the user's moving direction θ has changed. In one embodiment, a user's moving direction θ in a follow-me context is described in FIG. 6. As shown, when a mobile robot is following a user, at any particular time, the mobile robot's moving direction is defined as the forward direction. The angle θ between the user's moving direction and the forward direction is defined as the user's moving direction. In the example shown in FIG. 6, the user was moving in the forward direction up until he or she made a turn at location a to move to b. Thus, the user's moving direction has changed from 0° to θ.

As discussed above, the robot may use sensors (e.g., ultrasonic sensors, infrared sensors, depth sensors), LIDAR, or computer vision technology to determine the direction θ. For example, the method and system for using multiple ultrasonic sensors to determine the distance and direction of a target object (e.g., a person) from a mobile robot disclosed in the '116 Provisional Application may be used for determining the user's moving direction.

In one embodiment, the determination of the direction θ may be a separate and independent process which runs concurrently or in parallel with the process 500. The direction determination process may calculate the direction θ in real-time so that the process 500 may check its value whenever needed.

If the user's moving direction has not changed, the process 500 circles back to step 501 to continue to determine or check whether the user's moving direction has changed. Otherwise, the process 500 goes to step 502.

At step 502, the process 500 determines whether the mobile robot is currently moving (i.e., navigation speed is greater than 0). If no, the process 500 goes back to step 501. If yes, the process 500 goes to step 503. Thus, a mobile robot changes its direction only when it is moving. Alternatively, step 502 may be skipped so that a robot may pivot at its location to adjust its direction.

At step 503, the process 500 determines or checks the change of the user's moving direction |Δθ|. As discussed above, |Δθ| may be calculated in real-time by a separate and independent process which runs concurrently or in parallel with the process 500.

At step 504, the process 500 determines whether the change of direction |Δθ| exceeds the first threshold Ø1. If so, the process 500 goes to step 505, where it restarts a timer (e.g., 3 seconds) and goes back to step 503. If |Δθ| does not exceed the first threshold Ø1, the process 500 goes to 506.

At step 506, the process 500 checks whether the timer has expired. Note that the timer is initially set as expired. If the timer is expired, the process 500 goes to step 507, where it sends instructions to the robot's motor control module to adjust the robot's direction based on the user's present moving direction, speed, and/or position. Afterwards, the process 500 goes back to step 501.

In one embodiment, the processes 300 and 500 may run concurrently or in parallel as separate processes.

In one embodiment, a user can use the robot's follow-me function to train it to learn a particular navigation path so that it can navigate the same path autonomously. For example, while following the user, the mobile robot 100 constructs a map of its surrounding environment and records its locations with reference to the map. Later, the mobile robot 100 may autonomously navigate the same path by relying on the map and the recorded locations. As discussed above, the mobile robot 100 may use SLAM technologies to construct the map. The robot's locations may be a series of coordinates on the map.

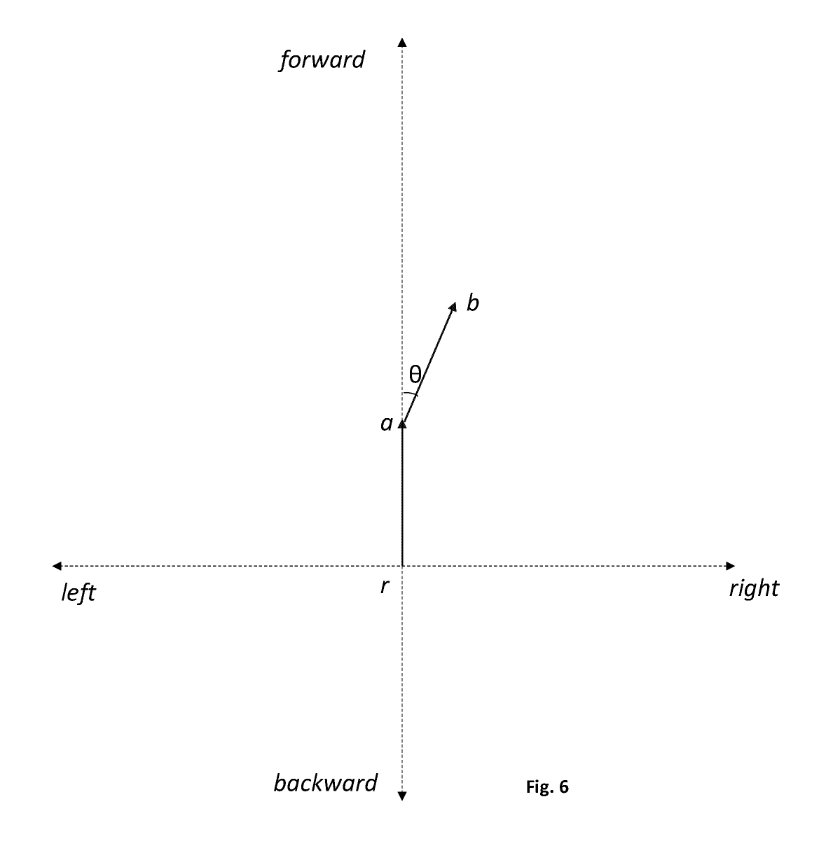

FIG. 7 illustrates an example of using a constructed map and a series of coordinates to record a robot's moving path during a follow-me training session. As shown, the robot's starting point is specified as the origin (0, 0) of the coordinate plane. In one embodiment, the mobile robot 100 includes a magnetometer that can determine directions. The mobile robot 100 may define the northern direction as the y coordinate and the eastern direction as the x coordinate. It uses the defined coordinate plane to construct a map and records its coordinates accordingly. The mobile robot 100 may record its coordinate at a specified interval (e.g., 10 milliseconds) to generate a coordinate list along the path. Alternatively, it records its coordinate only when it makes a direction change as shown in FIG. 7.

In one embodiment of the present invention, during the follow-me training session, the mobile robot 100 may also learn or be instructed to make a stop at a specified location (“anchor point”). For example, if the user being followed by the robot stops at a location for more than a specified time period (e.g., 30 seconds), the mobile robot 100 prompts the user to confirm that she intends the robot to make a stop there during its self-navigation of the same path in the future. There are various ways the robot can prompt the user to make the confirmation. For example, the robot may flash a light, sound an alarm, or even speak in a natural language (e.g., “Do you want me to stop here, Madam?”) to get the user's attention and confirmation. The user may confirm by push a button on the robot, make a gesture to the robot, or speak in natural language (e.g., “Yes, stop here.”) Furthermore, the user may also specify how long the stop should last. Otherwise, a default value is used for the length of the stop. If the user does not confirm within a specified time (e.g., 10 seconds) or provides a negative confirmation, the mobile robot 100 will ignore the current stop.

Alternatively, the user can specify an anchor point during the training without staying at the anchor point for an extended period of time. The user just needs to indicate that this is an anchor point. In a post processing stage (on a computer or a mobile device), the user can specify how long the robot has to stay at the anchor point. To indicate an anchor point to the robot and specify the time duration for the robot to stay at the anchor point, the user can use a PC keyboard or a mobile device on the robot or use voice commands.

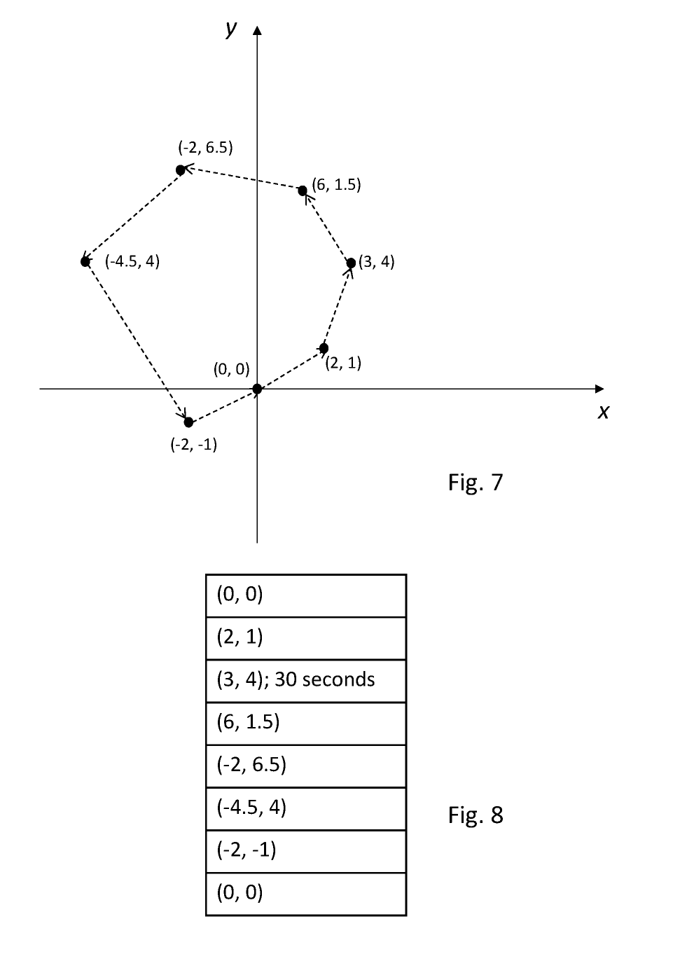

FIG. 8 shows a data structure including a list of coordinates corresponding to the path in FIG. 7. In addition, the data structure records one or more stops and the length of each stop. As shown, the robot is required to make a stop at coordinate (3, 4) for 30 seconds.

After the training, the mobile robot 100 may autonomously navigate the same path by relying on the map constructed during the training session and the recorded coordinate list. Assuming the mobile robot 100 returns to its original location (0, 0) in our example, it will navigate to the next coordinate (2, 1) from the list. From (2, 1), it will navigate to (3, 4) and stop there for 30 seconds.

In one embodiment, the stopping may be cut short by an intervening event. For example, a robot may be scheduled to deliver drinks to office workers during its self-navigation of a trained path. During the training, the robot was taught or instructed to stop at a cubicle for 30 seconds. But as soon as its weight sensor detects the weight change of its payload, suggesting the person sitting at the cubicle has picked up something from the robot's payload, the robot will move on to its next stop even if it has not stopped there for the whole 30 seconds.

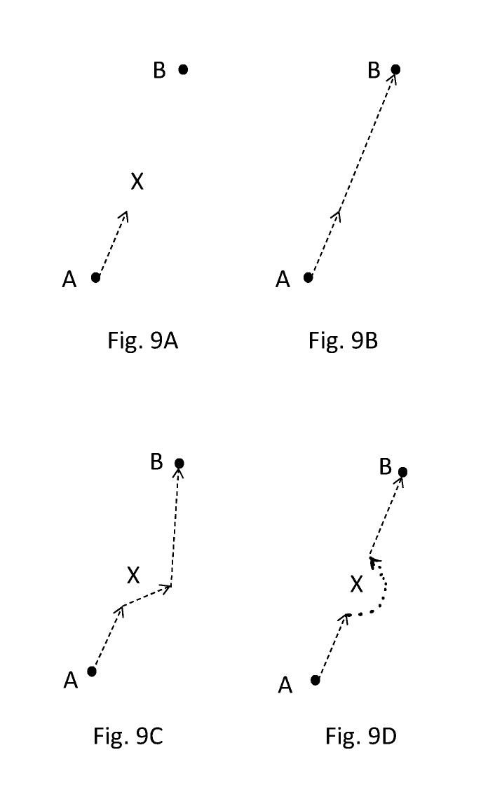

Furthermore, while a mobile robot is navigating on a trained path, it may encounter an unexpected obstacle. The robot may stop and wait for a specified time period (e.g., 5 seconds) to allow the obstacle to clear the path (e.g., in case the obstacle is a person or moving object). If the obstacle has not cleared the path after the specified time period, the robot will circumvent it to get to the target location. FIGS. 9A-9D illustrate such an example. As shown in FIG. 9A, the robot is trying to navigate from location A to location B. While on its way, the robot encounters obstacle X. The robot stops and waits for 5 seconds to allow X to clear the path. If X clears the path within 5 seconds, the robot will continue to move to B along the original course, as shown in FIG. 9B. If, however, X has not cleared the path with 5 seconds, the robot will circumvent X to get to B. There are several different ways to circumvent X. As shown in FIG. 9C, the robot may change its original course and find a new straight path to B. Alternatively, as shown in FIG. 9D, the robot may circle around X to get back to its original course to B.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. A method used in a mobile robot for following a person, the method comprising:
determining a distance between the robot and the person;
instructing the robot to start moving to follow the person only if the robot is not moving and the distance is greater than a first threshold; and
instructing the robot to stop moving only if the robot is moving and the distance is less than or equal to the second threshold;
wherein the first threshold is greater than the second threshold.

2. The method of claim 1 further comprising:
instructing the robot to speed up if the distance is increasing; and
instructing the robot to slow down if the distance is decreasing.

3. The method of claim 2 further comprising instructing the robot to alert the person if the distance is less than or equal to a third threshold, wherein the third threshold is less than the second threshold.

4. The method of claim 1, wherein the step instructing the robot to start moving to follow the person only if the robot is not moving and the distance is greater than a first threshold comprises instructing the robot to start moving to follow the person only if the robot is not moving, the distance is greater than a first threshold, and the distance is increasing.

5. A mobile robot that can follow a person, the mobile robot comprising:
a plurality of modules for collecting location related data regarding the person;
a motor control module for controlling a plurality of motors that drive the mobile robot; and
a main control module for executing a process comprising:
determining a distance between the robot and the person;
sending signals to instruct the motor control module to drive the plurality of motors to follow the person only if the robot is not moving and the distance is greater than a first threshold; and
sending signals to instruct the motor control module to stop the plurality of motors only if the robot is moving and the distance is less than or equal to the second threshold;
wherein the first threshold is greater than the second threshold.

6. The mobile robot of claim 5, wherein the plurality of modules includes one or more modules from the group comprising sensor module, camera module, LIDAR module, GPS module, and wireless module.

7. The mobile robot of claim 5, wherein the process further comprises:
sending signals to instruct the motor control module to speed up the plurality of motors if the distance is increasing; and
sending signals to instruct the motor control module to slow down the plurality of motors if the distance is decreasing.

8. The mobile robot of claim 5, wherein the process further comprises instructing the robot to alert the person if the distance is less than or equal to a third threshold, wherein the third threshold is less than the second threshold.

9. The mobile robot of claim 5, wherein the step sending signals to instruct the motor control module to drive the plurality of motors to follow the person only if the robot is not moving and the distance is greater than a first threshold comprises sending signals to instruct the motor control module to drive the plurality of motors to follow the person only if the robot is not moving, the distance is greater than a first threshold, and the distance is increasing.
